(19) United States
(12) Patent Application Publication
(10) Pub. No.: US 2009/0031914 A1
(43) Pub. Date: Feb. 5, 2009

(54) Backward Motion Stop

(75) Inventors: Andreas Hahn, Neuenstein (DE); Stefan Eberhardt, Soisdorf (DE)

Correspondence Address: CROWELL & MORING LLP;INTELLECTUAL PROPERTY GROUP, P.O. BOX 14300, WASHINGTON, DC, 20044-4300, US

(73) Assignee: Josef Wiegand GmbH & Co. KG, Rasdorf (DE)

(21) Appl. No.: 12/182,875

(22) Filed: Jul. 30, 2008

(30) Foreign Application Priority Data
Jul. 31, 2007 (DE) 102007036329.1

(51) Int. Cl. B61K 7/00; B61K 7/16; A63G 7/00; F16D 63/00

(52) U.S. Cl. 104/249; 188/82.7; 188/82.4

(57) ABSTRACT

A backward motion stop for a car to be pulled up in a guiding device is provided and consists of a catch lever engaging in a catch rail such that it operates noiselessly. For this purpose, an induction strut is laid parallel to the catch rail and the catch lever is equipped with a magnet interacting with the induction strut so that a linear eddy current brake is formed, which exercises a slight braking force counteracting the upward motion of the car upon the catch lever, which, because of the torque linked therewith, is moved out of the catch rail, so that it essentially floats over the catch rail.

### CROSS-REFERENCE TO RELATED APPLICATION

This application claims priority under 35 U.S.C. § 119 to German Patent Application No. DE 10 2007 036 329.1 filed Jul. 31, 2007, the entire disclosures of which are herein expressly incorporated by reference

### BACKGROUND AND SUMMARY OF THE INVENTION

The invention relates to a backward motion stop for a car moved upward on or in a guiding device, having a catch rail laid parallel to the guiding device and having a plurality of successively arranged catches and at least one catch lever swivelably held on the car and preventing a downward motion of the car by an engagement into one of the catches.

This backward motion stop is a safety element which prevents the car from rolling uncontrolled and unbraked downward on the rails when, for example, the traction cable breaks by which the car is pulled up on the rails. Such backward motion stops are used in many different systems, for example, also in the case of roller coasters.

In the simplest case, the stop rail consists of a rack rail, where each tooth of the rack rail has a steep flank and a slide flank so that, when the car moves upward, the catch lever is dragged over the slide flanks and, when the tip of the tooth is reached, falls into the tooth space that follows. In the event of a beginning backward motion of the car, the catch lever is pressed against the steep flank of the tooth situated behind it, whereby the backward motion is stopped and an uncontrolled downward motion of the car is prevented. Such backward motion stops have been successful and are being used frequently. Their only disadvantage is that a distinct noise is developed when the catch lever is falling into the tooth spaces following the rhythm of the teeth. In some riding businesses, this rattling noise development may intentionally contribute to increasing the passengers' excitement but is not desirable in every case. Although a damping pad on the side of the catch lever situated opposite the slide flank can reduce the development of noise, it has the disadvantage that it is subject to considerable wear and therefore has to be exchanged frequently.

It is therefore an object of the invention to develop a noiseless and wear-free backward motion stop which operates as safely as the previous ones.

For solving this problem, the invention provides that a linear eddy current brake is provided which is laid parallel to the guiding device and consists of an induction strut and a magnet arrangement having at least one magnet, which magnet arrangement interacts with the induction strut for generating a braking force, the catch lever being coupled with the induction strut or the magnet arrangement, and that the swiveling axis of the catch lever is physically arranged such with respect to the induction strut and the magnet arrangement that the braking force generated by the eddy current brake exercises a torque upon the catch lever so that, during an upward motion of the car, the latter is disengaged from the catches and, during a downward motion of the car engages with one of the catches of the catch rail.

As a result, the arrangement of the eddy current brake exercises a small braking force and thus a torque upon the catch lever because the swiveling axis of the catch lever is spaced away from the site of the introduction of braking force and with respect to the direction of the introduction of the braking force. The swiveling axis can now be arranged such that, during an upward motion of the car, the occurring torque ensures that the catch lever is moved away from the catch rail and thereby moves away over the catches. In the inverse case, that is, during a downward motion, the torque is reversed and the catch lever is moved into the catch rail and will place itself against one of the catches in order to stop the further downward motion of the car.

Such an arrangement is absolutely safe if the catch lever is arranged such that, under the effect of the force of gravity, which, as required, is supplemented by a corresponding torque, it definitely falls into the catch rail. This arrangement operates absolutely noiselessly because an opposite torque provides that the catch lever moves over the catch hook and does not come in contact with the catches as long as the car is moved upward.

For further increasing safety, the system may be constructed to be redundant in that two or, as required, even more catch levers are used.

Since the braking effect should be present over the entire path of the ascending guiding device, the induction strut is preferably laid parallel to the guiding device and along its entire length and the magnet arrangement is connected with the catch lever. Although an arrangement having a plurality of magnets along the guiding device and an induction strut constructed as a tongue on the car is conceivable, it would require too many expenditures in most cases.

In the simplest case, the induction strut is a vertically arranged metallic flat strut which extends parallel to the rack rail and at a distance from the latter.

Since the forces to be applied do not have to be very high but should only be sufficient for lifting the catch lever over the catches, the magnet arrangement needs to consist of only one magnet which is arranged on one side of the flat strut. Furthermore, a low braking force has the advantage that it can already be compensated by an only slightly increased tensile force.

In principle, the magnet may be a solenoid or a permanent magnet but, as a rule, a permanent magnet will be used because it saves high-expenditure cabling; although it cannot be completely excluded that the magnetic force of the permanent magnet might diminish over time. However, this would only have the result that the locking lever is not lifted completely out of the catch rail, so that a rattling noise would be generated again. This has no influence on the safety of the backward motion stop, so that the permanent magnet can be exchanged at the appropriate time.

As explained above, the catch rail preferably is a toothed rail with successive teeth whose respective upward-pointing flank (steep flank) is used as a stop for the catch lever and, for this purpose, extends almost perpendicular with respect to the longitudinal dimension of the toothed rail, and whose respective other downward-pointing flank (slide flank) is used as a slide face and, for this purpose, extends in a sloping manner with respect to the longitudinal dimension of the toothed rail.

In order to minimize the forces required for lifting the catch levers as much as possible, it is provided that a basic position in which the catch lever engages in the catch rail is a vertically suspended one. Since, in this case, the forces by which the catch lever supports itself on a steep flank cannot be supported by way of the swiveling axis on the car, an additional abutment for the catch lever is provided at the car.

Because the generated braking force and thereby the generated torque depends on the speed of the car, the forces during the start of the car will at first not be sufficient for lifting the catch lever completely out of the catch rail. In order to minimize as much as possible the accompanying initial noise development, a slope at the catch lever, which slides over the slide flank, is equipped with a noise-damping padding.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a longitudinal sectional view of the catch rail and the catch lever along Line I-I in FIG. 2; and

FIG. 2 is a view of the catch lever in the downward direction (direction of the arrow A).

### DETAILED DESCRIPTION OF THE DRAWINGS

The arrangement illustrated in the two figures consists of a catch lever 1 which is held on the rearward end of a car 2 in a swiveling axis 3.

The car 2 is pulled up by a pulling system in ascendingly laid rails, which are not shown here in detail and are used for its guidance, the connection with the pulling system being released at the highest point of the rails so that the car now travels downward independently on a path provided for this purpose. Parallel to the rails, a toothed rail 4 used as a catch rail is laid below the car and has a plurality of successive teeth 5 which each have a sloping slide flank 6 pointing in the downward direction and a vertically extending steep flank 7 pointing in the upward direction. By means of its lower wedge-shaped end, the catch lever 1 engages in the space between two teeth, a stop face 8 provided on the rearward side of the catch lever 1 placing itself against one of the steep flanks 7. Because the catch lever 1 simultaneously supports itself on the car 2 by way of an abutment 9 arranged below the swivel bearing 3, a downward motion of the car 2 in the direction of the arrow A is prevented in this manner. The abutment 9 at the catch lever 1 is constructed as a rubber buffer.

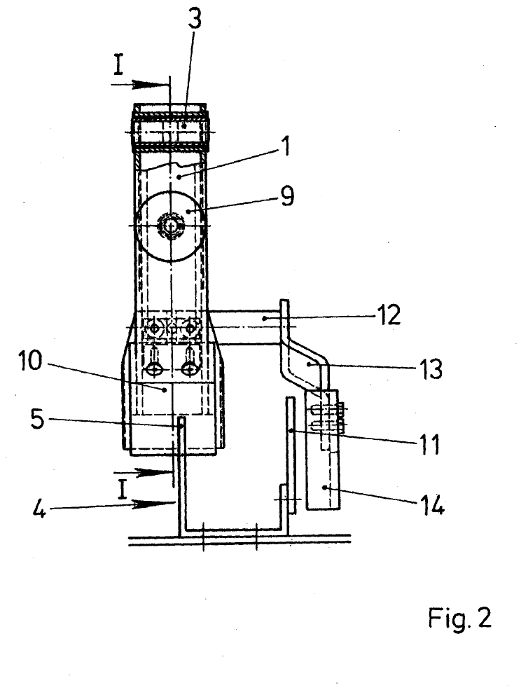

Without further measures, a slope 10 on the forward side of the lower end of the catch lever 1 would slide over the slide flanks 6 of the teeth 5 during an upward motion of the car 2, without in the process hindering the upward motion of the car 2. Because of the force of gravity acting upon it, the catch lever 1 would fall into a corresponding tooth space behind each tooth 5, whereby rattling noises are generated. In order to prevent this, as illustrated in FIG. 2, an induction strut 11 in the form of a metallic and non-magnetic flat strut, for example, made of aluminum, is laid parallel to the toothed rail 4. In addition, a magnet 14 is fastened to the catch lever 1 by way of a traverse 12 and an arm 13, which magnet is situated on the exterior side—that is the side facing away from the toothed rail 4—of the induction strut 11.

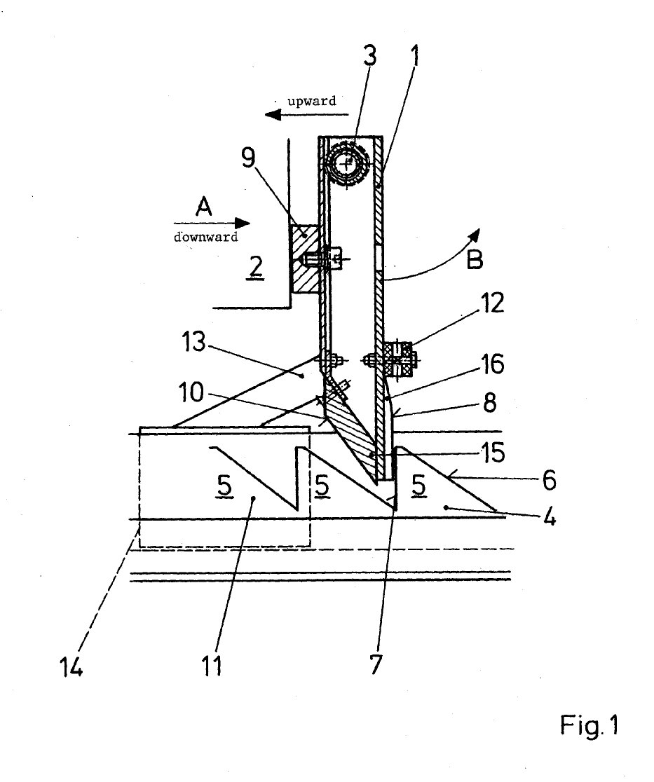

When the magnet 14 is moved with the catch lever 1 along the induction strut 11, it generates an induction current whose magnetic field is opposite to the motion and therefore has a braking effect. In this case, this means that, as illustrated in FIG. 1, the catch lever moves counterclockwise in the direction of the arrow B, so that its wedge-shaped end is moved out of the toothed rail 4. During an upward motion, the catch lever therefore “floats” above the teeth 5 so that no rattling noises can be generated. Inversely: When the pulling system fails so that the car threatens to roll uncontrolled down the rails, this result in a small initial downward motion of the magnet 14, whereby the braking force exercised thereby, together with the force of gravity, pulls the catch lever 1 back into the position illustrated in FIG. 1. This has the result that, as illustrated in FIG. 1, the catch lever 1 engages again in the toothed rail.

In order to reduce the noise as much as possible during an initial motion, during which the catch lever 1 has not yet been sufficiently lifted, the slope 10 has a damping pad 15.

So that the braking will not take place in an excessively jerky manner, the abutment 9, on the one hand, has an elastic design. In addition, a clamp 16 may be fastened to the stop face 8 of the catch lever 1, which stop face 8 interacts with the steep flank 7, which clamp 16 prevents a lateral sliding-off of the catch lever 1 from the respective tooth. In the simplest case, the clamp 16 consists of two legs projecting in a V-shape and is arranged such that the tooth 5 arrives between these legs when the catch lever 1 supports itself on the steep flank 7. In the process, the edges extending between the steep flank 7 and the lateral surface of the tooth 5 place themselves against the legs of the clamp 16.

Table of Reference Numbers

| | |
|---|---|
| 1 | Catch lever |
| 2 | car |
| 3 | swiveling axis |
| 4 | toothed rail |
| 5 | teeth |
| 6 | slide flank |
| 7 | steep flank |
| 8 | stop face |
| 9 | abutment |
| 10 | slope |
| 11 | induction strut |
| 12 | traverse |
| 13 | arm |
| 14 | magnet |
| 15 | damping pad |
| 16 | clamp |

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A backward motion stop for a car moved upward on or in a guiding device, comprising:
a catch rail laid parallel to the guiding device and having a plurality of successively arranged catches and at least one catch lever swivelably held on the car and preventing a downward motion of the car by an engagement into one of the catches;
a linear eddy current brake laid parallel to the guiding device and including an induction strut and a magnet arrangement having at least one magnet, which magnet arrangement interacts with the induction strut for generating a braking force;
wherein the catch lever is coupled with the induction strut or the magnet arrangement, and the swiveling axis of the catch lever is physically arranged with respect to the induction strut and the magnet arrangement such that the braking force generated by the eddy current brake exercises a torque upon the catch lever;
whereby during an upward motion of the car, the catch lever disengages from the catches and, during a downward motion of the car, the catch lever engages with one of the catches of the catch rail.

2. The backward motion stop according to claim 1, wherein the induction strut extends parallel to the guiding device along its entire length, and wherein the magnet arrangement is connected with the catch lever.

3. The backward motion stop according to claim 2, wherein the induction strut is a vertically arranged metallic flat strut, which extends parallel to the catch rail and at a distance from the catch rail, and wherein the magnet arrangement comprises only one magnet, which is arranged on one side of the flat strut.

4. The backward motion stop according to claim 3, wherein the magnet is a permanent magnet.

5. The backward motion stop according to claim 1, wherein the catch rail is a toothed rail with successive teeth whose respective one flank is used as stop for the catch lever and, for this purpose, extends almost perpendicular with respect to the longitudinal dimension of the toothed rail, and whose respective other flank is used as a slide surface and, for this purpose, extends in a sloping fashion with respect to the longitudinal dimension of the toothed rail.

6. The backward motion stop according to claim 2, wherein the catch rail is a toothed rail with successive teeth whose respective one flank is used as stop for the catch lever and, for this purpose, extends almost perpendicular with respect to the longitudinal dimension of the toothed rail, and whose respective other flank is used as a slide surface and, for this purpose, extends in a sloping fashion with respect to the longitudinal dimension of the toothed rail.

7. The backward motion stop according to claim 3, wherein the catch rail is a toothed rail with successive teeth whose respective one flank is used as stop for the catch lever and, for this purpose, extends almost perpendicular with respect to the longitudinal dimension of the toothed rail, and whose respective other flank is used as a slide surface and, for this purpose, extends in a sloping fashion with respect to the longitudinal dimension of the toothed rail.

8. The backward motion stop according to claim 4, wherein the catch rail is a toothed rail with successive teeth whose respective one flank is used as stop for the catch lever and, for this purpose, extends almost perpendicular with respect to the longitudinal dimension of the toothed rail, and whose respective other flank is used as a slide surface and, for this purpose, extends in a sloping fashion with respect to the longitudinal dimension of the toothed rail.

9. The backward motion stop according to claim 5, wherein, in a position in which it engages with the flank of one of the teeth of the toothed rail, which flank is used as a stop, the catch lever rests against an abutment on the car.

10. The backward motion stop according to claim 6, wherein, in a position in which it engages with the flank of one of the teeth of the toothed rail, which flank is used as a stop, the catch lever rests against an abutment on the car.

11. The backward motion stop according to claim 7, wherein, in a position in which it engages with the flank of one of the teeth of the toothed rail, which flank is used as a stop, the catch lever rests against an abutment on the car.

12. The backward motion stop according to claim 8, wherein, in a position in which it engages with the flank of one of the teeth of the toothed rail, which flank is used as a stop, the catch lever rests against an abutment on the car.

13. The backward motion stop according to claim 5, wherein the catch lever has a slope which is equipped with a noise-damping padding.

14. The backward motion stop according to claim 6, wherein the catch lever has a slope which is equipped with a noise-damping padding.

15. The backward motion stop according to claim 7, wherein the catch lever has a slope which is equipped with a noise-damping padding.

16. The backward motion stop according to claim 8, wherein the catch lever has a slope which is equipped with a noise-damping padding.
